(19) United States
(12) Patent Application Publication
(10) Pub. No.: US 2020/0169767 A1
(43) Pub. Date: May 28, 2020

(54) Systems, Methods And Computer Program Products For Delivering Audio And Video Data Through Multiplexed Data Streams

(71) Applicant: Peter Hackes, Arlington, VA (US)

(72) Inventor: Raghav Tandon, New Delhi (IN)

(21) Appl. No.: 16/697,304

(22) Filed: Nov. 27, 2019

(30) Foreign Application Priority Data
Nov. 27, 2018 (IN) 201811044774

(51) Int. Cl. H04N 21/2368; H04N 21/2187; H04N 21/233; H04N 21/234; H04N 21/434; H04N 21/439; H04N 21/44; H04N 21/242; H04N 21/8547; H04N 21/2387

(52) U.S. Cl. CPC H04N 21/2368; H04N 21/2187; H04N 21/233; H04N 21/234; H04N 21/2387; H04N 21/439; H04N 21/44; H04N 21/242; H04N 21/8547; H04N 21/4348

(57) ABSTRACT

The invention provides systems, methods and computer program products for delivering audio and video data from a plurality of source terminals, to one or more end point terminals through multiplexed data streams. The invention comprises (i) receiving from a plurality of source terminals, a distinct video signal stream and a distinct audio signal stream, (ii) transmitting to each end point terminal, a multiplexed video signal stream comprising composite video frames, wherein each video frame within a composite video frame is (a) extracted from a distinct video signal stream, and (b) time synchronized with one or more other video frames within said composite video frame, and (iii) transmitting to each end point terminal, a multiplexed audio signal stream comprising a composite audio signal, wherein the composite audio signal comprises a composite of time synchronized audio samples, each extracted from a distinct audio signal stream.

### FIELD OF THE INVENTION

The present invention relates to the domain of network based videos streaming, and more particularly to systems, methods and computer program products for time synchronized multiplexing and demultiplexing of video data streams received from a plurality of video source terminals or multimedia source terminals.

### BACKGROUND

Multimedia webcasting systems known within the art utilize a variety of media types and sources. Modern systems typically consist of systems configured to provide real-time broadcasts or multicasts of video data streams or multimedia data streams that include at least video and audio data over the internet, or via a streaming medium, to a plurality of remote users—who may be physically scattered across different areas in a building, different cities or countries, or different continents. The streamed content is usually distributed live and may be either interactive or non-interactive.

FIG. 1 illustrates an exemplary multi-source streaming system 100 comprising a plurality of source terminals 102a, 102b upto to 102n participating in a streaming session. Each source terminal 102a to 102n is configured to transmit video and/or audio data that is either captured live or that is retrieved from a video/audio data source (not shown) to one or more end point terminals 108a to 108n that are recipients in the streaming session, through network 104.

As illustrated in FIG. 1, each source terminal 102a to 102n may comprise a communication platform configured for network streaming of video and/or audio data—and may include by way of example, any of computing devices, servers, smartphones, web cameras and/or wired or wireless cameras. Said source terminals 102a to 102n may each be configured (through software, hardware or a combination thereof) to communicate with a streaming session controller 106—which is accessible through network 104. Typically, in a multi-source streaming environment (for example, a webcast environment) the source terminals used for live streaming include video cameras, laptops, software or hardware encoders which transmit the source stream(s) to a streaming server or infrastructure that is connected to a Content Distribution Network (CDN). Viewers/end point terminals 108a to 108n pull the stream from the CDN or directly from the streaming server.

Session controller 106 may be configured to receive video and audio streams from each source terminal participating in a streaming session, and to route to each participating end point terminal, video and/or audio data that has been received from the plurality of source terminals—in a time synchronized manner, such that each receiving end point terminal receives in real time (or substantially in real time) audio and video data streamed from all of the source terminals.

For streaming efficiency and with a view to ensure that audio and video streams from multiple different source terminals are received at each receiving end point terminal in a time synchronized manner, existing solutions for multi-source video or multimedia streaming provide for generation of mixed audio and video streams. The mixed audio stream is generated by time synchronizing audio data received from each source terminal and generating a mixed audio stream comprising audio data from the multiple source terminals—which mixed audio stream is then transmitted to each end point terminal for playback. Likewise, the mixed video stream is generated by time synchronizing video data received from each source terminal and generating a mixed video stream comprising video data from the multiple source terminals—which mixed video stream is then transmitted to each end point terminal for playback.

It has however been found that prior art solutions provide limited flexibility in terms of extracting data from the received mixed data streams (particularly from the received mixed video streams), as receiving end point terminals are unable to demultiplex video data that has been generated by each transmitting source terminal—and are instead limited to playback of the mixed video data stream as an amalgamated or composite video stream.

There is accordingly a need for improved solutions for time synchronized multiplexing and demultiplexing of source terminal data in a multi-source video or multimedia streaming session.

### SUMMARY

The invention provides systems, methods and computer program products for delivering video data (and optionally, audio data) through multiplexed data streams.

In an embodiment, the invention provides a method for delivering audio and video data from a plurality of source terminals, to one or more end point terminals through a plurality of multiplexed data streams. The method comprises (i) receiving from each of the plurality of source terminals, a distinct video signal stream and a distinct audio signal stream, and (ii) transmitting to each end point terminal, a multiplexed video signal stream comprising a set of composite video frames, each composite video frame comprising a composite of video frames, wherein each video frame composited within a composite video frame is (a) extracted from one of the distinct video signal streams received from the plurality of source terminals, and (b) time synchronized with one or more other video frames within said composite video frame.

In an embodiment, the method further comprises (i) receiving from each of the plurality of source terminals, a distinct audio signal stream, and (ii) transmitting to each end point terminal, a multiplexed audio signal stream comprising a composite audio signal, wherein the composite audio signal comprises a composite of time synchronized audio samples, each extracted from a distinct audio signal stream received from one of the plurality of source terminals.

In an embodiment of the method, the multiplexed video signal stream and the multiplexed audio signal stream are distinct data streams.

The method may further include transmitting to each end point terminal, an output video frame definition, wherein the output video frame definition identifies regions or areas within a composite video frame, at which individual video frames that have been combined within the composite video frame are positioned.

In a particular method embodiment, the output video frame definition correlates each identified region or area within the composite video frame with a source terminal that has generated a video frame positioned within said identified region or area.

In another embodiment of the method, the output video frame definition defines attributes for video frames from each of the plurality of source terminals when multiplexing such video frames into a composite video frame.

In a further embodiment of the method, the defined attributes for video frames from each of the plurality of source terminals, comprise attributes that determine any of location, dimensions, resolution and size of video frames generated by the respective source terminal when such video frames are multiplexed into a composite video frame for the multiplexed video signal stream.

In a more particular embodiment of the method, the defined attributes for video frames from each of the plurality of source terminals comprise attributes that determine any of location, dimensions, resolution and size of video frames generated by the respective source terminal when such video frames are multiplexed into a composite video frame for the multiplexed video signal stream.

In one method embodiment, each end point terminal is configured to (i) extract a plurality of video frames from one or more received composite video frames within the transmitted multiplexed video signal stream, and (ii) display the plurality of video frames extracted from each composite video frame on a display.

The plurality of video frames extracted from each composite video frame may be displayed as a plurality of discrete video frames displayed simultaneously on the display. Each end point terminal may be configured to generate audio output on an audio playback device within or coupled with the end point terminal based on the received multiplexed audio signal stream, wherein the audio output is generated without demultiplexing the multiplexed audio signal stream.

The invention additionally provides a system configured for delivering audio and video data from a plurality of source terminals, to one or more end point terminals through a plurality of multiplexed data streams. The system comprises a processor implemented session controller configured to (i) receive from each of the plurality of source terminals, a distinct video signal stream and a distinct audio signal stream, and (ii) generate a multiplexed video signal stream comprising a set of composite video frames, each composite video frame comprising a composite of video frames, wherein each video frame composited within a composite video frame is (a) extracted from one of the distinct video signal streams received from the plurality of source terminals, and (b) time synchronized with one or more other video frames within said composite video frame.

In a further embodiment, the system may be configured to (i) receive from each of the plurality of source terminals, a distinct audio signal stream, and (ii) generate a multiplexed audio signal stream comprising a composite audio signal, wherein the composite audio signal comprises a composite of time synchronized audio samples, each extracted from a distinct audio signal stream received from one of the plurality of source terminals—wherein at least one of the multiplexed video signal stream and the multiplexed audio signal stream are transmitted to each end point terminal.

In an embodiment of the system, the session controller is configured such that the generated multiplexed video signal stream and the generated multiplexed audio signal stream are distinct data streams.

The session controller may further be configured to transmit to each end point terminal, an output video frame definition, wherein the output video frame definition identifies regions within a composite video frame, at which individual video frames that have been combined within the composite video frame are positioned.

In a system embodiment, the output video frame definition correlates each identified region or area within the composite video frame with a source terminal that has generated a video frame positioned within said identified region or area.

The system may be configured such that the output video frame definition, defines attributes for video frames from each of the plurality of source terminals when multiplexing such video frames into a composite video frame.

The system may additionally be configured such that the defined attributes for video frames from each of the plurality of source terminals, comprise attributes determine any of location, dimensions, resolution and size of video frames generated by the respective source terminal when such video frames are multiplexed into a composite video frame for the multiplexed video signal stream.

The attribute information may be multiplexed as a data stream in the composite video stream or as a data stream via an independent network stream. In an exemplary embodiment, a separate communication channel (for example, a communication channel established using websockets) can be established between a session controller and one or more end point terminals, to transmit attribute information to such one or more end point terminals—which attribute information can be used by each of the one or more end point terminals to configure its corresponding playback viewer/video stream player to extract and display video frames from within the composite video stream.

In a particular embodiment of the system, each end point terminal is configured to (i) extract a plurality of video frames from one or more received composite video frames within the transmitted multiplexed video signal stream, and (ii) display the plurality of video frames extracted from each composite video frame on a display.

In another system embodiment, the plurality of video frames extracted from each composite video frame is displayed as a plurality of discrete video frames displayed simultaneously on the display.

Each end point terminal within the system may be configured to generate audio output on an audio playback device within or coupled with the end point terminal based on the received multiplexed audio signal stream, wherein the audio output is generated without demultiplexing the multiplexed audio signal stream.

The invention also provides a computer program product for playback of audio and video data that is delivered a plurality of source terminals, to one or more end point terminals through a plurality of multiplexed data streams. The computer program product comprises a non-transitory computer readable medium having a computer readable program code embodiment therein, the computer readable program code comprising instructions for (i) receiving from each of the plurality of source terminals, a distinct video signal stream and a distinct audio signal stream, and (ii) transmitting to each end point terminal, a multiplexed video signal stream comprising a set of composite video frames, each composite video frame comprising a composite of video frames, wherein each video frame composited within a composite video frame is (a) extracted from one of the distinct video signal streams received from the plurality of source terminals, and (b) time synchronized with one or more other video frames within said composite video frame.

### BRIEF DESCRIPTION OF THE ACCOMPANYING DRAWINGS

FIG. 1 illustrates an exemplary multi-source video system or multimedia streaming system.

FIG. 2 illustrates the components and operation of an exemplary session controller within a multi-source video system or multimedia streaming system.

FIGS. 3A to 3C show illustrative video frames generated by the session controller based on video streams received from a plurality of source terminals participating in a multi-source video streaming session or a multimedia streaming session.

FIG. 4 illustrates an exemplary source terminal of a type used for participating in a multi-source video session or multimedia streaming session, configured in accordance with the teachings of the present invention.

FIG. 5 illustrates a method of videostream and audiostream multiplexing in accordance with the present invention.

FIG. 6 illustrates a method of videostream demultiplexing in accordance with the present invention.

FIG. 7 illustrates an exemplary computer system according to which various embodiments of the present invention may be implemented.

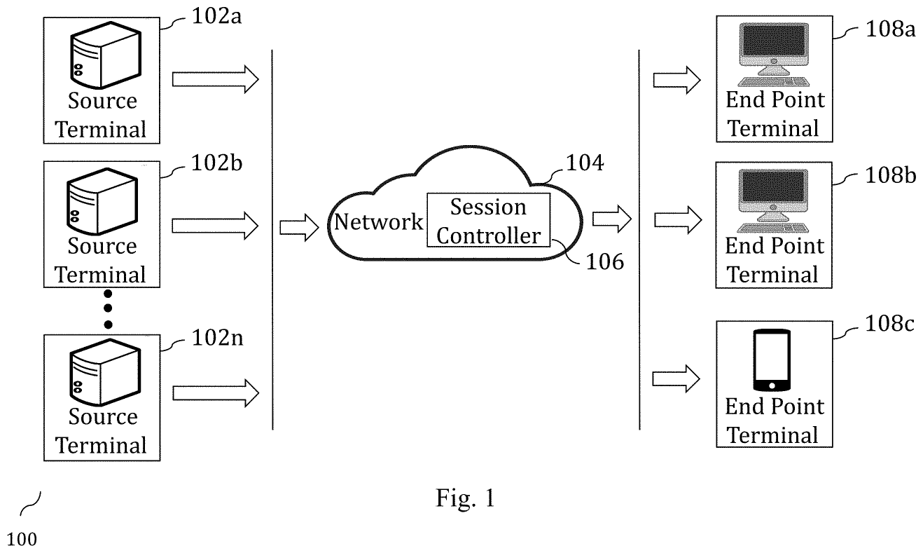

### DETAILED DESCRIPTION OF THE INVENTION

The invention provides apparatuses and methods for multiplexing audio and video bitstreams received from a plurality of source terminals in a multi-source video session or multimedia streaming session, transmission of the multiplexed bitstreams to participant end point terminals, demultiplexing and playback of individual video bitstreams, and playback of the received audio bitstream, at each receiving end point terminal.

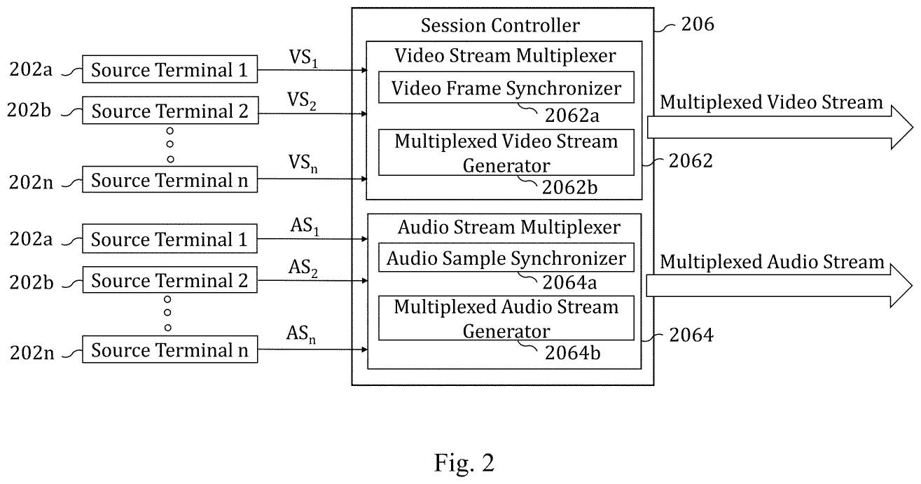

FIG. 2 illustrates an embodiment of a session controller 206 configured to receive individual audio and video bitstreams from each source terminal participating in the multi-source video session or multimedia streaming session, and to generate mixed/multiplexed video and audio bitstreams for transmission to each participating end point terminal.

As shown in FIG. 2, session controller 206 comprises video stream multiplexer 2062 and audio stream multiplexer 2064.

Video stream multiplexer 2062 comprises video frame synchronizer 2062a and multiplexed video stream generator 2062b. Video stream multiplexer 2062 is configured to receive video streams VS1 to VSn respectively from source terminals 1 to n (i.e. source terminals 202a, 202b upto 202n) that are participating in a multi-source video session or multimedia streaming session, and to output a multiplexed video stream comprising video stream data from each of video streams VS1 to VSn. Video stream multiplexer 2062 achieves this through (i) video frame synchronizer 2062a which is configured to group video frames from the plurality of video streams VS1 to VSn based on a frame synchronization method that identifies and groups video frames extracted from the plurality of video streams VS1 to VSn and which have the same or substantially the same time stamps, and (ii) multiplexed video stream generator 2062b, which generates a multiplexed video stream, wherein each video frame within the multiplexed video stream is a multiplexed video frame comprising individual video frames that have been received from each source terminal, and that have been grouped together by the video frame synchronizer 2062a based on the frame synchronization method. Each multiplexed video frame within the multiplexed video stream comprises a composite video frame having specific regions (or sub-frames) within which individual video frames (that have been extracted from each of video streams VS1 to VSn and grouped based on corresponding time stamp data) are amalgamated for display.

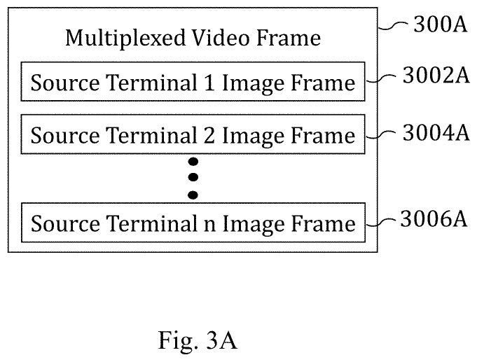

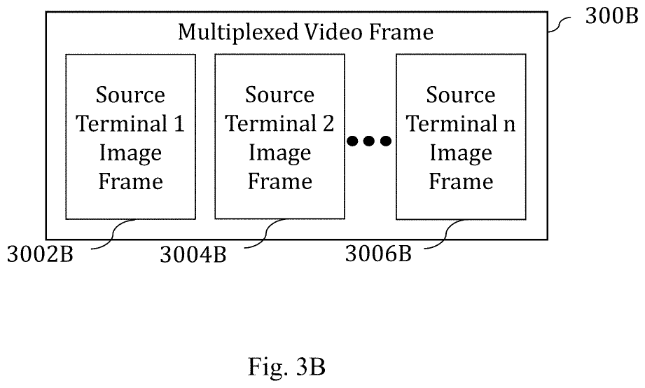

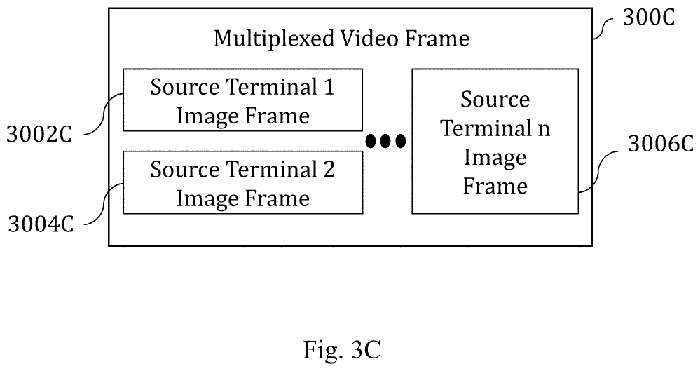

It will be understood that the individual video frames that are multiplexed into each video frame within the multiplexed video stream may be organized or located in any number of configurations, including any of:
a vertical stacking configuration shown in multiplexed video frame 300A of FIG. 3A, wherein a first video frame 3002A generated by source terminal 1 (202a), a second video frame 3004A generated by source terminal 2 (202b), upto an n^{th} video frame 3006A generated by source terminal n (202n) are stacked vertically within the multiplexed composite video frame 300A,
a horizontal stacking configuration shown in multiplexed video frame 300B of FIG. 3B, wherein a first video frame 3002B generated by source terminal 1 (202a), a second video frame 3004B generated by source terminal 2 (202b), upto an n^{th} video frame 3006B generated by source terminal n (202n) are stacked horizontally within the multiplexed composite video frame 300B,
a hybrid stacking (comprising horizontal and vertical stacking) configuration shown in the multiplexed video frame 300C of FIG. 3C, wherein the stacking of a first video frame 3002C generated by source terminal 1 (202a), a second video frame 3004C generated by source terminal 2 (202b), upto an n^{th} video frame 3006C generated by source terminal n (202n) is a combination of horizontal and vertical stacking within the multiplexed composite video frame 300C.

In certain embodiments of the invention, each time any source terminal (202a to 202n) joins or drops out of a multi-source video or multimedia streaming session, the merging/stacking format used for generating the plurality of multiplexed video frames may change, to accommodate the updated number of session participants, and subsequent multiplexed video frames may be generated based on the new/updated merging or stacking format.

It will be further understood that video stream multiplexer 2062 may be configured to select a template for generating composite video frames for the multiplexed video stream, which template defines attributes that are to be assigned to video frames from each source terminal (202a to 202n) participating in the session, when such video frames from each source terminal are multiplexed into composite video frames. The defined attributes that are to be assigned to video frames from each source terminal (202a to 202n) may include, without limitation, any one or more of location, dimension(s), resolution, and/or size attributes. The attributes defined in respect of video frames from a particular source terminal (202a to 202n) may define any of location, dimension, resolution and/or size attributes that are to be applied to video frames from that particular source terminal, when multiplexing such video frames into one or more composite video frames. As a result, when a multiplexed (composite) video frame is generated based on individual video frames received from a plurality of source terminals, the attributes (e.g. location, dimension, resolution and/or size attributes) of individual video frames within the multiplexed (composite) video frame are determined based on attribute information extracted from the template for generating composite video frames for the multiplexed video stream. Thus, in an embodiment, the attributes (for e.g. the location, dimensions, resolution and/or size of video frames originating from a particular source terminal when multiplexed into a composite video frame) are determined based on the corresponding attributes (e.g. location, dimension, resolution and/or size attributes) assigned to that particular source terminal within the selected template for generating composite video frames for the multiplexed video stream. In certain embodiments of the invention, each time a source terminal joins or drops out of a multi-source video session or multimedia streaming session, the template selected and used to generate the plurality of multiplexed or composite video frames may change, to accommodate the updated number of source terminals, and subsequent multiplexed video frames may be generated based on the new/updated template.

Video stream multiplexer 2062 may additionally be configured to optionally generate an output video frame definition message—which output video frame definition message may comprise definition information describing the any attributes (e.g. location, dimension(s), resolution, and/or size attributes) corresponding to individual video frames that are extracted from each of input video streams VS1 to VSn and are subsequently composited within a multiplexed video frame, and optionally also the identity of the respective source terminal that has generated the video frame that is being composited within the multiplexed video frame. Alternatively, each participant end point terminal may have a predefined output video frame definition stored therewithin, which definition corresponds to or describes the template for generating video frames for the multiplexed video stream that is used by video stream multiplexer 2062. In an embodiment, location attributes may be described in terms of x and y coordinates, and resolution, dimensions and size attributes may be defined in terms of units of width and height.

Audio stream multiplexer 2064 comprises audio sample synchronizer 2064a and multiplexed audio stream generator 2064b. Audio stream multiplexer 2064 is configured to receive audio streams AS1 to ASn respectively from source terminals 1 to n (202a upto 202n) that are participating in the multi-source video session or multimedia streaming session, and to output a multiplexed audio stream comprising audio stream data from each of audio streams AS1 to Asn. Audio stream multiplexer 2064 achieves this through (i) audio sample synchronizer 2064a which is configured to group audio samples/audio data from the plurality of audio streams AS1 to Asn based on an audio synchronization method that identifies and groups audio samples/audio data extracted from the plurality of audio streams AS1 to Asn and which have the same or substantially the same time stamps, and (ii) multiplexed audio stream generator 2064b, which generates a multiplexed audio stream, wherein audio data within the multiplexed audio stream includes audio samples/audio data that have been grouped together by the audio sample synchronizer 2024a based on the audio synchronization method.

Each of the multiplexed video stream, multiplexed audio stream, and the output video frame definition message (generated by video stream multiplexer 2062 and/or multiplexed video stream generator 2062b) may be transmitted to each end point terminal participating in the multi-source video session or multimedia streaming session. In embodiments of the invention, each time a source terminal joins or drops out of a multi-source video session or multimedia streaming session, an updated output video frame definition message may be generated by video stream multiplexer 2062 and/or multiplexed video stream generator 2062b (reflecting the new multiplexed frame definition necessitated by the joining or dropping out of the source terminal) and may be transmitted to each participating end point terminal.

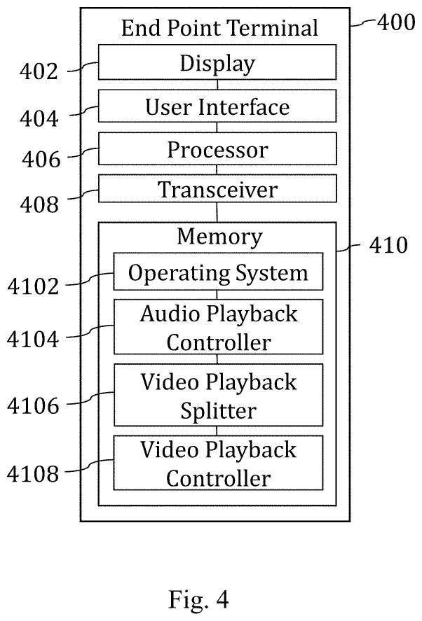

FIG. 4 illustrates an exemplary multi-source video session or multimedia streaming session end point terminal 400 configured in accordance with the teachings of the present invention. End point terminal 400 comprises display 402, user interface 404, processor 406, transceiver 408 and memory 410. Memory 410 comprises operating system 4102, a processor implemented audio playback controller 4104, a processor implemented video playback splitter 4106, and a processor implemented video playback controller 4108.

Each of display 402, user interface 404, processor 406, transceiver 408, memory 410 and operating system 4102 may be understood to be configured and to operate in accordance with methods that would be apparent to the skilled person.

Audio playback controller 4104 may be configured to receive the multiplexed audio stream generated by audio stream multiplexer 2064 within session controller 206, to extract audio data from the multiplexed audio stream and to playback said audio data through one or more audio playback devices or peripherals located within or communicably coupled with end point terminal 400. In an embodiment of the invention, audio playback controller 4104 is configured to playback audio data extracted from the multiplexed audio stream without demultiplexing the audio data into the individual audio streams that were used to generate said multiplexed audio stream.

Video playback splitter 4106 is configured to receive the multiplexed video stream generated by video stream multiplexer 2062 within session controller 206, and to demultiplex the composite video frames within the received multiplexed video stream so as to extract from each such composite video frame, the individual video frames (sub-frames) that have been generated by each source terminal and that have been amalgamated into said composite video frame.

In an embodiment of the invention, video playback splitter 4106 may be configured to receive the most recent or most current output video frame definition message generated by the video stream multiplexer 2022/composite video stream generator 2022b—wherein said output video frame definition message identifies attributes (e.g. location, dimension, resolution and/or size attributes) of individual video frames (that have been generated by and correspond to individual source terminals) within composite video frames of the multiplexed video stream. Video playback splitter 4106 may additionally be configured to extract individual video frame data/sub-frame data from within the composite video frames, for display as individual video stream frames, wherein the step of extracting individual video frame data/sub-frame data generated by a particular source terminal relies on the identified attributes (e.g. location, dimension, resolution and/or size attributes) associated with video frames generated by that source terminal within the output video frame definition message.

In another embodiment, video playback splitter 4106 may be configured to (i) retrieve a predefined output video frame definition stored within the end point terminal 400, which definition corresponds to or describes the template for generating video frames for the multiplexed video stream that has been used by video stream multiplexer 2022. Said output video frame definition is used by video playback splitter 4106 to identify attributes (e.g. location, dimension, resolution and/or size attributes) of individual video frames (that have been generated by end point terminal 400) within composite video frames of the multiplexed video stream that correspond to individual source terminals, and to extract individual frame data/sub-frame data corresponding to video frames generated by end point terminal 400 from within the composite video frames, for display as individual video stream frames.

In another embodiment, video playback splitter 4106 may be configured to use techniques of image analysis to identify attributes (e.g. any of location, dimension, resolution and/or size attributes) corresponding to individual frames or sub-frames that have been combined or mosaiced within composite video frames of the composite video frames of the multiplexed video stream that correspond to individual source terminals (for example, edge detection techniques or any number of other techniques that would be apparent to the skilled person), and to extract individual frame data/sub-frame data from within the composite video frames, for display as individual video stream frames.

Video playback splitter 4106 may additionally be configured to output a plurality of demultiplexed video streams—each comprising a stream of video frames generated by an individual source terminal, each of which video frames has been extracted from a discrete composite video frame within the multiplexed video stream received from video stream multiplexer 2062.

Video playback controller 4108 is configured to receive from video playback splitter 4106, each of the plurality of demultiplexed video streams, and to display one or more of the plurality of demultiplexed video streams within a video player/media player on display 402. One or more of video playback controller 4108, user interface 404 and display 402 may be configured to enable a user/operator of end point terminal 400 to configure display preferences to adjust or modify the display attributes (for example, any of size, resolution and display location attributes) corresponding to one or more of the plurality of demultiplexed video streams.

It would be understood that responsive to a participating source terminal joining or dropping out of a multi-source video session or multimedia streaming session, the number of demultiplexed video streams output by video playback splitter 4106 and that are displayed through video playback controller 4108 may change, and a user may (through user interface 404) change the display attributes (for example, any of size, resolution and display location attributes) of one or more of the updated set of demultiplexed video streams for playback through display 402.

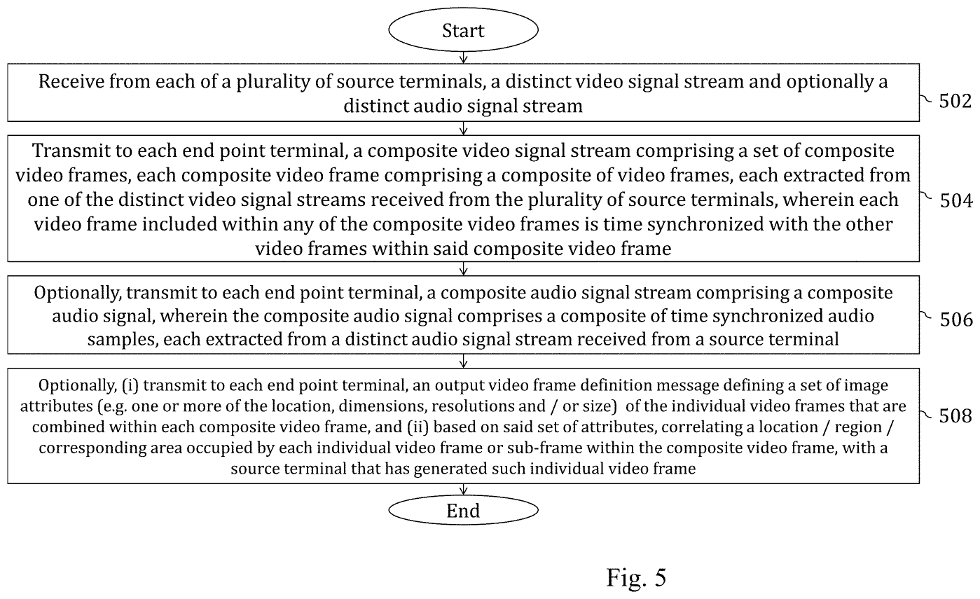

FIG. 5 illustrates a method of generating multiplexed video and audio streams in accordance with the teachings of the present invention, which method may in an embodiment be implemented by the session controller 206 of FIG. 2.

Step 502 comprises receiving from each of a plurality of source terminals (202a to 202n), a distinct video signal stream, and optionally a distinct audio signal stream.

Step 504 comprises transmitting to each participating end point terminal, a multiplexed video signal stream comprising a set of composite video frames, each composite video frame comprising a composite of video frames, each extracted from one of the distinct video signal streams received from the plurality of source terminals (202a to 202n), wherein each video frame included within any of the composite video frames is time synchronized with the other video frames within said composite video frame.

Step 506 comprises optionally transmitting to each participating end point terminal, a composite audio signal stream comprising a composite audio signal, wherein the composite audio signal comprises a composite of time synchronized audio samples, each extracted from a distinct audio signal stream received from one of the plurality of source terminals (202a to 202n).

Step 508 comprises optionally (i) transmitting to each participating end point terminal, an output video frame definition message defining a set of attributes—which attributes may in an embodiment comprise one or more of the respective location, dimension, resolution and/or size attributes corresponding to individual video frames or sub-frames (generated by and correspond to each participating end point terminal) that have been composited within each composite video frame at which individual video frames (that have been combined within the composite video frame) have been combined or mosaiced, and (ii) based on this set of attributes, correlating a location/region/corresponding area occupied by each individual video frame or sub-frame within the composite video frame, with a source terminal (202a to 202n) that has generated said video frame(s)/sub-frame within a composite video frame. In an embodiment, location attributes may be described in terms of x and y coordinates, resolution, dimensions and size attributes may be defined in terms of units of width and height.

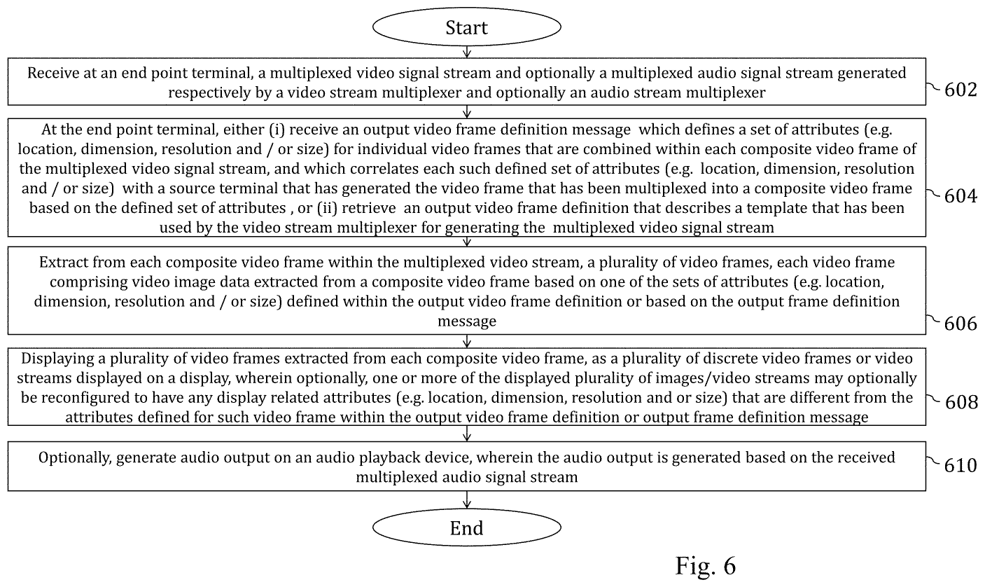

FIG. 6 illustrates a method of videostream demultiplexing in accordance with the teachings of the present invention, which method may, in various embodiments, be implemented by end point terminal 400 of FIG. 4.

Step 602 comprises receiving at an end point terminal 400 that is participating in a multi-source video session or multimedia streaming session, a multiplexed video signal stream and optionally, a multiplexed audio signal stream generated respectively by a video stream multiplexer and an audio stream multiplexer.

Step 604 comprises implementing at the end point terminal 400, the steps of either (i) receiving at the end point terminal 400, a multiplexed video stream definition message, (a) that defines a set of attributes (e.g. any of location, dimension, resolution and/or size attributes) corresponding to individual video frames or sub-frames (that have been generated by a specific source terminal) and that have been multiplexed within composite video frames of the multiplexed video stream, and (b) that also correlates each set of attributes (e.g. one or more of defined location, dimension, resolution and/or size attributes) with a source terminal (202a to 202n) from which video frames are received and thereafter multiplexed into composite video frames of the multiplexed video signal stream based on the correlated set of attributes (e.g. any of location, dimension, resolution and/or size attributes), or (ii) retrieving from a memory storage associated with the end point terminal, a predefined output video frame definition, which definition corresponds to or describes the template for generating video frames for the multiplexed video stream that has been used by a video stream multiplexer to generate the multiplexed video signal stream. In an embodiment, location attributes may be described in terms of x and y coordinates, resolution, dimensions and size attributes may be defined in terms of units of width and height.

The multiplexed video stream definition message and/or the predefined output video frame definition discussed at step 604 may in an embodiment be multiplexed as a data stream within the composite video stream or as a data stream via an independent network stream. In an exemplary embodiment, a separate communication channel (for example, a communication channel established using websockets) can be established between a session controller and one or more end point terminals, to transmit attribute information to such one or more end point terminals which attribute information can be used by each of the one or more end point terminals to configure its corresponding playback viewer/video stream player to extract and display video frames from within the composite video stream.

Step 606 comprises extracting from each composite video frame within the multiplexed video stream, a plurality of video frames, each video frame comprising video data that has been extracted from a composite video frame based on one of the sets of attributes (e.g. any one or more of location, dimension, resolution and/or size attributes) defined within the output video frame definition (that has been received or retrieved at step 604) or based on the output frame definition message (that has been received or retrieved at step 604).

Step 608 thereafter comprises displaying the plurality of video frames extracted from each composite video frame, as a plurality of discrete video frames displayed simultaneously on a display. Optionally, step 608 may further include the step of reconfiguring or reformatting or up-sampling or down-sampling one or more of the displayed plurality of video frames to have any of location, dimension, resolution and or size related display attributes that are different from the location, dimension, resolution and or size related attributes defined for such video frame within the output video frame definition or output frame definition message

Step 610 comprises optionally generating an audio output on an audio playback device, wherein the audio output is generated based on the received multiplexed audio signal stream. In an embodiment, the audio output is generated based on the multiplexed audio signal stream without prior demultiplexing of the multiplexed audio signal stream. In a further embodiment, the audio playback device is integrated within or is coupled with end point terminal 400.

It would be understood that implementing the teachings of the present invention provides a flexible solution for extracting or demultiplexing individual videostream data from a received multiplexed video stream, as the receiving end point terminals are now able to separately demultiplex video data that has been generated by each transmitting source terminal—and can therefore process and playback each demultiplexed video stream from within the multiplexed video stream, as a discrete video stream—which provides each end terminal with a host of improved video stream display and control capabilities.

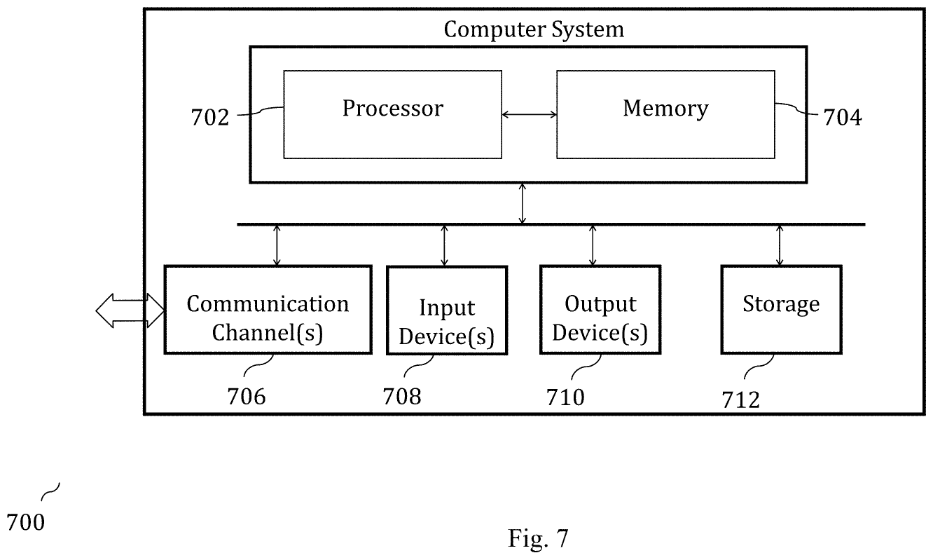

FIG. 7 illustrates an exemplary system 700 for implementing the present invention.

System 700 includes computer system 700 which in turn comprises one or more processors 702 and at least one memory 704. Processor 702 is configured to execute program instructions—and may be a real processor or a virtual processor. It will be understood that computer system 700 does not suggest any limitation as to scope of use or functionality of described embodiments. The computer system 700 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 700 in accordance with the present invention may include one or more servers, desktops, laptops, tablets, smart phones, mobile phones, mobile communication devices, tablets, phablets and personal digital assistants. In an embodiment of the present invention, the memory 704 may store software for implementing various embodiments of the present invention. The computer system 700 may have additional components. For example, the computer system 700 may include one or more communication channels 706, one or more input devices 708, one or more output devices 710, and storage 712. An interconnection mechanism (not shown) such as a bus, controller, or network, interconnects the components of the computer system 700. In various embodiments of the present invention, operating system software (not shown) provides an operating environment for various softwares executing in the computer system 700 using a processor 702, and manages different functionalities of the components of the computer system 700.

The communication channel(s) 706 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 708 may include, but is not limited to, a touch screen, a keyboard, mouse, pen, joystick, trackball, a voice device, a scanning device, or any another device that is capable of providing input to the computer system 700. In an embodiment of the present invention, the input device(s) 708 may be a sound card or similar device that accepts audio input in analog or digital form. The output device(s) 710 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 700.

The storage 712 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 700. In various embodiments of the present invention, the storage 712 may contain program instructions for implementing any of the described embodiments.

In an embodiment of the present invention, the computer system 700 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 700. The method described herein is typically implemented as a computer program product, comprising a set of program instructions that is executed by the computer system 700 or any other similar device. The set of program instructions may be a series of computer readable codes stored on a tangible medium, such as a computer readable storage medium (storage 712), for example, diskette, CD-ROM, ROM, flash drives or hard disk, or transmittable to the computer system 700, via a modem or other interface device, over either a tangible medium, including but not limited to optical or analogue communications channel(s) 706. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

What is claimed is:

1. A method for delivering video data from a plurality of source terminals, to one or more end point terminals through a plurality of multiplexed data streams, the method comprising:
receiving from each of the plurality of source terminals, a distinct video signal stream; and
transmitting to each end point terminal, a multiplexed video signal stream comprising a set of composite video frames, each composite video frame comprising a composite of video frames, wherein each video frame composited within a composite video frame is:
extracted from one of the distinct video signal streams received from the plurality of source terminals; and
time synchronized with one or more other video frames within said composite video frame.

2. The method as claimed in claim 1, further comprising:
receiving from each of the plurality of source terminals, a distinct audio signal stream; and
transmitting to each end point terminal, a multiplexed audio signal stream comprising a composite audio signal, wherein the composite audio signal comprises a composite of time synchronized audio samples, each extracted from a distinct audio signal stream received from one of the plurality of source terminals.

3. The method as claimed in claim 2, wherein the multiplexed video signal stream and the multiplexed audio signal stream are distinct data streams.

4. The method as claimed in claim 1, further comprising transmitting to each end point terminal, an output video frame definition, wherein the output video frame definition identifies regions within a composite video frame, at which individual video frames that have been combined within the composite video frame are positioned.

5. The method as claimed in claim 4, wherein the output video frame definition correlates each identified region or area within the composite video frame with a source terminal that has generated a video frame positioned within said identified region or area.

6. The method as claimed in claim 3, wherein the output video frame definition defines attributes for video frames from each of the plurality of source terminals when multiplexing such video frames into a composite video frame.

7. The method as claimed in claim 6, wherein the defined attributes corresponding to each of the plurality of source terminals, comprise attributes that determine any of location, dimensions, resolution and size of video frames generated by the respective source terminal when such video frames are multiplexed into a composite video frame for the multiplexed video signal stream.

8. The method as claimed in claim 1, wherein each end point terminal is configured to:
extract a plurality of video frames from one or more received composite video frames within the transmitted multiplexed video signal stream; and
display the plurality of video frames extracted from each composite video frame on a display.

9. The method as claimed in claim 8, wherein the plurality of video frames extracted from each composite video frame are displayed as a plurality of discrete video frames displayed simultaneously on the display.

10. The method as claimed in claim 8, wherein each end point terminal is further configured to generate audio output on an audio playback device within or coupled with the end point terminal based on the received multiplexed audio signal stream, wherein the audio output is generated without demultiplexing the multiplexed audio signal stream.

11. A system configured for delivering audio and video data from a plurality of source terminals, to one or more end point terminals through a plurality of multiplexed data streams, the system comprising a processor implemented session controller configured to:
receive from each of the plurality of source terminals, a distinct video signal stream; and
generate a multiplexed video signal stream comprising a set of composite video frames, each composite video frame comprising a composite of video frames, wherein each video frame composited within a composite video frame is:
extracted from one of the distinct video signal streams received from the plurality of source terminals; and
time synchronized with one or more other video frames within said composite video frame.

12. The system as claimed in claim 11, further configured to:
receive from each of the plurality of source terminals, a distinct audio signal stream; and
generate a multiplexed audio signal stream comprising a composite audio signal, wherein the composite audio signal comprises a composite of time synchronized audio samples, each extracted from a distinct audio signal stream received from one of the plurality of source terminals;
wherein at least one of the multiplexed video signal stream and the multiplexed audio signal stream are transmitted to each end point terminal.

13. The system as claimed in claim 11, wherein the session controller is configured such that the generated multiplexed video signal stream and the generated multiplexed audio signal stream are distinct data streams.

14. The system as claimed in claim 11, wherein the session controller is configured to transmit to each end point terminal, an output video frame definition, wherein the output video frame definition identifies regions within a composite video frame, at which individual video frames that have been combined within the composite video frame are positioned.

15. The system as claimed in claim 14, wherein the output video frame definition correlates each identified region or area within the composite video frame with a source terminal that has generated a video frame positioned within said identified region or area.

16. The system as claimed in claim 13, wherein the output video frame definition, defines attributes for video frames from each of the plurality of source terminals when multiplexing such video frames into a composite video frame.

17. The system as claimed in claim 16, wherein the defined attributes corresponding to each of the plurality of source terminals, comprise attributes that determine any of location, dimensions, resolution and size of video frames generated by the respective source terminal when such video frames are multiplexed into a composite video frame for the multiplexed video signal stream.

18. The system as claimed in claim 11, wherein each end point terminal is configured to:
extract a plurality of video frames from one or more received composite video frames within the transmitted multiplexed video signal stream; and
display the plurality of video frames extracted from each composite video frame on a display.

19. The system as claimed in claim 18, wherein the plurality of video frames extracted from each composite video frame is displayed as a plurality of discrete video frames displayed simultaneously on the display.

20. The system as claimed in claim 18, wherein each end point terminal is further configured to generate audio output on an audio playback device within or coupled with the end point terminal based on the received multiplexed audio signal stream, wherein the audio output is generated without demultiplexing the multiplexed audio signal stream.

21. A computer program product for playback of audio and video data that is delivered a plurality of source terminals, to one or more end point terminals through a plurality of multiplexed data streams, the computer program product comprising a non-transitory computer readable medium having a computer readable program code embodiment therein, the computer readable program code comprising instructions for:
receiving from each of the plurality of source terminals, a distinct video signal stream and a distinct audio signal stream; and
transmitting to each end point terminal, a multiplexed video signal stream comprising a set of composite video frames, each composite video frame comprising a composite of video frames, wherein each video frame composited within a composite video frame is:
extracted from one of the distinct video signal streams received from the plurality of source terminals; and
time synchronized with one or more other video frames within said composite video frame.
